(19) United States
(12) Patent Application Publication
(10) Pub. No.: US 2012/0264592 A1
(43) Pub. Date: Oct. 18, 2012

(54) COMPOSITIONS, MATERIALS INCORPORATING THE COMPOSITIONS, AND METHODS OF USING THE COMPOSITIONS AND MATERIALS

(75) Inventors: Zhen Luo, Suwanee, GA (US); Daniel A. Hillesheim, Lenoir City, TN (US); Iourii V. Gueletii, Decatur, GA (US); Craig L. Hill, Atlanta, GA (US)

(73) Assignee: EMORY UNIVERSITY, Atlanta, GA (US)

(21) Appl. No.: 13/388,460

(22) PCT Filed: Sep. 8, 2010
(86) PCT No.: PCT/US10/48085

§ 371 Date: Feb. 16, 2012

Related U.S. Application Data
(60) Provisional application No. 61/241,150, filed on Sep. 10, 2009.

(51) Int. Cl. B01J 27/24; B01J 27/25; B01J 31/26; B01J 31/28

(52) U.S. Cl. 502/164; 502/200; 502/201

(57) ABSTRACT

The invention relates to composition and methods of using described compositions as oxidative catalysis. In certain embodiments, the invention relates to a composition having a nitrogen oxide species, bromide ion, a metal, and oxygen. In certain embodiments, the composition catalyzes sulfides.

### STATEMENT REGARDING FEDERALLY SPONSORED RESEARCH OR DEVELOPMENT

This invention was made with government support under grant numbers HDTRA1-09-1-0002 and W911NF-05-1-0200, awarded by Defense Threat Reduction Agency and Army Research Office (ECBC), respectively. The government has certain rights in the invention.

### BACKGROUND

Decreasing the danger of contaminants (e.g., sulfur compounds, aldehydes, and warfare agents) has long been a significant issue. Compositions that can protect and/or remove contaminants from the environment in which people are operating can significantly decrease problems associated with contaminants. Various compositions have been used, but in many instances the compositions do not protect and/or remove contaminants in an efficacious manner. Thus, a heretofore unaddressed need exists in the industry to develop materials that are effective against contaminants.

The sulfur mustards, of which mustard gas (1,5-dichloro-3-thiapentaneotherwise known as HD), is a member, are a class of related cytotoxic, vesicant chemical warfare agents with the ability to form large blisters on exposed skin There are known species that decontaminate HD by stoichiometric reaction. However, these reagents such as the Sandia Foam, the German emulsion, and Decon Green, as well as the older STB (Tropical Standard Bleach, a concentrated basic solution of NaOCl) and DS2 (hydroxide in glyme type solvents) typically contain a large amount of oxidant and are usually corrosive or deleterious to skin and many surfaces. Also these systems are not amenable to use as solids. Special containers are needed for their storage. As a consequence, they are not viable as components of self-decontaminating coatings, fabrics, cosmetics (such as topical skin protectants, TSPs), filter materials, etc. It would be desirable to develop a catalytic system for dealing with contaminants, particularly for volatile agents.

Boring et al., Journal of Molecular Catalysis A: Chemical 176 (2001) 49-63 disclose a Au(III)/(Br)₂/NO₃/Cu(II) system for the aerobic oxidation of an HD analogue, 2-chloroethyl ethyl sulfide (CEES), to 2-chloroethyl ethyl sulfoxide (CEESO) under ambient conditions. However, there exists a need to identify improved compositions and methods.

### SUMMARY

The invention relates to composition and methods of using described compositions as oxidative catalysis. In certain embodiments, the invention relates to a composition having a nitrogen oxide species, bromide ion, a metal, and oxygen. In a typical embodiment, a composition catalyzes sulfides made from mixing of copper and iron bromide and nitrile salts.

In some embodiments, the invention relates to a composition comprising: a M1 compound source, a M2 compound source, a NOx compound source, where x is 1, 2, or 3, and a Br compound source, wherein the composition including M1/M2/NOx/Br— has the characteristic of being able to degrade a contaminant.

In some embodiments, the invention relates to a mixture comprising: a M1 compound source, a M2 compound source, a NOx compound source, where x is 1, 2, or 3, and a Br compound source, wherein the mixture including M1/M2/NOx/Br— has the characteristic of being able to degrade a contaminant.

In some embodiments, the invention relates to compositions or mixtures of disclosed herein wherein M1 is Cu and M2 is Fe.

In some embodiments, the invention relates to compositions or mixtures of disclosed herein wherein the composition is a catalyst.

In some embodiments, the invention relates to a composition comprising: a M1 compound, and a Br compound source, and a NOx source, wherein the composition including M1/NOx/Br— has the characteristic of being able to degrade a contaminant.

In some embodiments, the invention relates to a mixture comprising: a M1 compound, and a Br compound source, and a NOx source, wherein the composition including M1/NOx/Br— has the characteristic of being able to degrade a contaminant.

In some embodiments, the invention relates to compositions or mixtures of disclosed herein, wherein M1 is selected from Cu and Fe. In certain embodiments, M1 is Cu.

In some embodiments, the invention relates to a composition comprising: a M1 compound, and a Br compound source, a NOx source where x is 1, 2, or 3, and E, wherein the composition including M1/E/NOx/Br— has the characteristic of being able to degrade a contaminant, wherein E is selected from the group consisting of: tetraethylammonium (TEA) or tetra-n-butylammonium (TBA), tetrahexylammonium, tetraheptylammonium, tetramethylammonium, tetramethylphosphonium, tetraphenylphosphonium, tetraphenylarsonium, related polyalkyl or polyaryl cations, and any combination thereof.

In some embodiments, the invention relates to a mixture comprising: a M1 compound, and a Br compound source, a NOx source where x is 1, 2, or 3, and E, wherein the composition including M1/E/NOx/Br— has the characteristic of being able to degrade a contaminant, wherein E is selected from the group consisting of: tetraethylammonium (TEA) or tetra-n-butylammonium (TBA), tetrahexylammonium, tetraheptylammonium, tetramethylammonium, tetramethylphosphonium, tetraphenylphosphonium, tetraphenylarsonium, related polyalkyl or polyaryl cations, and any combination thereof.

In some embodiments, the invention relates to a composition or mixture of as disclosed herein, wherein the composition including M1/E/NOx/Br— includes Cu(NO3)2, TBANO3, TBABr, TBABr3, and NaHCO3.

In certain embodiments, the composition is a catalyst.

In some embodiments, the invention relates to a composition, comprising: M1/NOx:EM2(Hal)y, wherein M1 and M2 are independently selected from: copper (Cu), iron (Fe), chromium (Cr), cobalt (Co), nickel (Ni), manganese (Mn), and zinc (Zn); wherein E is selected from the group consisting of: tetraethylammonium (TEA) or tetra-n-butylammonium (TBA), tetrahexylammonium, tetraheptylammonium, tetramethylammonium, tetramethylphosphonium, tetraphenylphosphonium, tetraphenylarsonium, related polyalkyl or polyaryl cations, and any combination thereof; wherein Hal is selected from the group consisting of: bromine (Br), chlorine (Cl), and any combination thereof; wherein y is 2 or 4; and wherein “x” is 1, 2, or 3.

In some embodiments, the invention relates to mixture, comprising: M1/NOx and EM2(Hal)y, wherein M1 and M2 are independently selected from: copper (Cu), iron (Fe), chromium (Cr), cobalt (Co), nickel (Ni), manganese (Mn), and zinc (Zn); wherein E is selected from the group consisting of: tetraethylammonium (TEA) or tetra-n-butylammonium (TBA), tetrahexylammonium, tetraheptylammonium, tetramethylammonium, tetramethylphosphonium, tetraphenylphosphonium, tetraphenylarsonium, related polyalkyl or polyaryl cations, and any combination thereof; wherein Hal is selected from the group consisting of: bromine (Br), chlorine (Cl), and any combination thereof; wherein y is 2 or 4; and wherein “x” is 1, 2, or 3.

In some embodiments, the invention relates to a composition or mixture as disclosed herein, wherein Hal is bromine (Br), E is tetra-n-butylammonium (TBA), M1 is Cu, M2 is Fe, and NOx is [NO3-].

In certain embodiment, the composition or mixture disclosed herein further comprises an acid. In certain embodiments, the acid is selected from the group consisting of an alkylsulfonic acid or fluorinated derivatives thereof, an arylsulfonic acid or fluorinated derivatives thereof, and any combination of these. In further embodiments, the acid is selected from the group consisting of: toluenesulfonic acid, sulfonic acid, nitric acid, and any combination thereof.

In some embodiments, the invention relates to material is selected from a fabric, a topical carrier, a powder, a filter material, a coating or a porous material, including nanoporous or microporous materials comprising compositions or mixtures disclosed herein.

In certain embodiments, the invention relates to compositions comprising/consisting essentially of a tetraalkylamine, a nitrogen oxide ion, bromine ion, a metal, and oxygen. In certain embodiments, the composition catalyzes the oxidation of sulfur containing compounds. Typically, thiols are oxidize to disulfides and thiol esters are oxidized to sulfoxides.

In further embodiments, the invention relates to methods of oxidizing a sulfide comprising mixing a sulfide and a composition made by the process of mixing a nitrogen oxide species and a bromide salt under conditions such that a disulfide or sulfoxide form. In certain embodiments, the composition further comprises copper and iron salts.

In certain embodiments, the invention relates to compositions made by the process of mixing a tetraalkylamine nitrite salt, a metal bromide, and an acid.

In certain embodiments, the invention relates to compositions made by the process of mixing Cu(NO3)2, TBABr, FeBr3, and an acid. In certain embodiments, the invention relates to compositions comprising a 1:1 molar mixture of Cu(NO3)2, TBABr, and an iron salt, typically FeBr₃ or FeCl₃.

In certain embodiments, the invention relates to compositions made by the process of mixing TBABr, TBABr3, TBANO3, Cu(NO3)2, and NaHCO3.

In accordance with the present disclosure, as embodied and broadly described herein, embodiments of this disclosure, in one aspect, relate to compositions, mixtures, materials incorporating the composition or mixture, and methods of use thereof, for the protection, degradation, and/or decontamination of contaminants. Embodiments of the present disclosure are advantageous because they can be made from inexpensive components and can degrade contaminants in air (e.g., using O₂ as the oxidant) at ambient temperatures. In particular, embodiments of the present disclosure can be used to degrade contaminants without the use of heat (elevated temperatures above ambient), light, additives including any other reagents, or other requirements, or other compositions or mixtures. In an embodiment, the oxidation is selective and no harmful by-products result from catalytic reaction of the contaminant. In addition, embodiments of the present disclosure are catalytic whereby non-stoichiometric amounts of catalyst can decontaminate large quantities of contaminants (e.g., target molecules).

In an illustrative embodiment, the composition or mixtures can be used in deodorizing sprays, topical skin protectants, coatings for use indoors, fabrics that are not exposed to H₂O (e.g., upholstery, carpeting, and the like), liners for shoes (e.g., running shoes, dress shoes, and the like), coatings for outdoor use (e.g., coatings not exposed to H₂O), fabrics for garments that are not washed, filters and filtration systems (e.g., coatings on the fibers of the filter and on portions of the filtration system and/or incorporated in the fibers or fabric of the filter), and other fabrics as well. Embodiments of the compositions may be used in combination with solvents to store and deliver the compositions.

Embodiments of the present disclosure include compositions, mixtures, materials, and the like, that include M1/NOₓ/Br⁻, M1/E/NOₓ/Br⁻, and/or M1/M2/NOₓ/Br⁻, each of which have the characteristic of being able to degrade a contaminant. In particular, the composition or mixture can include a M1 compound source (e.g., M1/NOₓ), a M2 compound source (e.g., EM2(Hal)_{y}), a NOₓ compound source (e.g., M1/NOₓ), where x is 1, 2, or 3, a Br compound source (e.g., EM2(Hal)_{y}), and/or E, as is appropriate for M1/NOₓ/Br⁻, M1/E/NOₓ/Br⁻, and/or M1/M2/NOₓ/Br⁻. The compound sources are compounds that provide the particular atom or ion so that the combination can be used to degrade the contaminant. Each of M1 and M2 can independently include, but is not limited to, copper (Cu), iron (Fe), chromium (Cr), cobalt (Co), nickel (Ni), manganese (Mn), and zinc (Zn), or other d-electron-containing transition-metals. In an embodiment, M1 and M2 are Cu and Fe. It should be noted that in an embodiment NOₓ could be replaced by NO⁺, NO₃⁻ or NO₂⁻. It should also be noted that a notation of NOₓ includes [NO₃⁻], [NO₂⁻], [NO⁺], or [NO₂⁺], for purposes of this disclosure. In an embodiment, Br⁻ can be replaced with another halogen (e.g., Cl) or combination of halogens. “E” can include, but is not limited to, tetraethylammonium (TEA) or tetra-n-butylammonium (TBA), tetrahexylammonium, tetraheptylammonium, tetramethylammonium, tetramethylphosphonium, tetraphenylphosphonium, tetraphenylarsonium, related polyalkyl or polyaryl cations, and any combination thereof.

In particular, embodiments of the present disclosure include compositions, mixtures, materials, and the like, that include M1/NOₓ:EM2(Hal)_{y}, which has the characteristic of being able to degrade a contaminant. Each of M1 and M2 can independently include, but is not limited to, copper (Cu), iron (Fe), chromium (Cr), cobalt (Co), nickel (Ni), manganese (Mn), and zinc (Zn), or other d-electron-containing transition-metals. In an embodiment, each of M1 and M2 are independently selected from Cu and Fe (e.g., Cu/NOₓ and EFe(Hal)₄). “E” can include, but is not limited to, tetraethylammonium (TEA) or tetra-n-butylammonium (TBA), tetrahexylammonium, tetraheptylammonium, tetramethylammonium, tetramethylphosphonium, tetraphenylphosphonium, tetraphenylarsonium, related polyalkyl or polyaryl cations, and combinations thereof. “Hal” is a halogen (e.g., bromine (Br), chlorine (Cl)), y is 2 or 4, and “x” is 1, 2, or 3. It should be noted that in an embodiment NOₓ could be replaced by NO⁺, NO₃⁻ or NO₂⁻. It should be noted that a notation of NOₓ includes [NO₃⁻] or [NO₂⁻] for purposes of this disclosure. For embodiments including M1/NOₓ:EM2(Hal)_{y} can be from about 1:15 to 15:1 or abou 1:10 to 10:1 (e.g., the numbers can be in increments of 0.1). In an embodiment, the ratio is about 1:1.

It should be noted that embodiments of the present disclosure (e.g., M1/NOₓ:EM2(Hal)_{y}) may be represented as a mixture of components such as, but not limited to, EM1(Hal)_{y} and M2(NO₃)₂. In an embodiment, the mixture may be of TBAFeBr₄ and Cu(NO₃)₂. In an embodiment the composition can include a mixture of TBAFeBr₄ and Cu(NO₃)₂. The amount TBAFeBr₄ in the composition or mixture is about (broad range) 10 to 90 mole percent of the composition or about (working range) 30 to 70 mole percent of the composition or mixture. The amount for Cu(NO₃)₂ in the composition or mixture is about 90 to 10 mole percent of the composition or about 70 to 30 mole percent of the composition or mixture. One skilled in the art can determine the composition of the formula in view of the teachings provided herein.

In an embodiment, the composition including M1/E/NOₓBr⁻ can include Cu(NO₃)₂, TBANO₃, TBABr, TBABr₃, and NaHCO₃. This embodiment exhibits highly efficient catalysis/absorption of mercaptans.

In each of the embodiments noted herein, the composition or mixture can be used with and/or include an acid. In an embodiment, the acid can be toluenesulfonic acid or other organosulfonic acids including but not limited to methane sulfonic acid, nitric acid, and triflic acid, or sulfuric acid or other strong nontoxic mineral acids, or sufficiently strong organic acids or any combination thereof. The amount the acid in the composition or mixture is about (broad range) 0.5 to 10 mole percent of the composition or mixture or about (working range) 1 to 4 mole percent of the composition or mixture.

Embodiments of the present disclosure can also include tribromide salts.

### BRIEF DESCRIPTION OF THE FIGURES

FIG. 1 shows data on the effects of different transition-metal halides as sources of bromide on the catalytic conversion of CEES to CEESO by the “NOx/Br” system under homogeneous conditions. Yellow: 2.5 mM TBANO3, 2.5 mM CuBr2, 10 mM p-TsOH; Blue: 2.5 mM TBANO3, 2.5 mM NiBr2, 5.0 mM p-TsOH; Red: 2.5 mM NOPF6, 2.5 mM NiBr2, 10 mM p-TsOH; Green: 2.5 mM TBANO2, 2.5 mM CuBr2, 10 mM p-TsOH; Black: 2.5 TBANO3, 1.3 mM TBAFeBr4, 10 mM p-TsOH. Conditions: 3.0 mL acetonitrile, 100 microL CEES (0.86 mmoles, 286 mM), 100 microL DCB (0.88 mmoles, 292 mM), 1 atm oxygen at room temperature.

FIG. 2 shows data on the effects of different transition-metal bromides and nitrates as sources of bromide and NOx on the catalytic conversion of CEES to CEESO by the “NOx/Br” system under homogeneous conditions. Red square: 1.0 mM Cu(NO3)2, 1.0 mM TBAFeBr4, 2.0 mM p-TsOH; Blue square: 0.67 mM Fe(NO3)3, 1.0 mM CuBr2, 2.0 mM p-TsOH; Red circle: 1.0 mM Cu(NO3)2, 1.0 mM TBAFeBr4; Blue circle: 0.67 mM Fe(NO3)3, 2.0 mM CuBr2; Black x: 2.0 mM TBANO3, 1.0 mM TBAFeBr4, 2.0 mM p-TsOH; Black circle: 0.67 mM Fe(NO2)3, 4.0 mM TBABr, 2.0 mM p-TsOH; Green x: 2.0 mM TBANO3, 2.0 mM CuBr2, 2.0 mM p-TsOH; Green circle: 1.0 mM Cu(NO3)2, 4.0 mM TBABr, 2.0 mM p-TsOH. Conditions: 3 mL acetonitrile. 1 atm oxygen at 40 C, 50 microL DCB.

FIG. 3 shows data on gas-phase decontamination (air-based oxidative removal) of propanethiol (PrSH) by solid catalyst.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, organic chemistry, inorganic chemistry, and the like, which are within the skill of the art.

The following examples are put forth so as to provide those of ordinary skill in the art with a complete disclosure and description of how to perform the methods and use the probes disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a compound” includes a plurality of compounds. In this specification and in the claims that follow, reference will be made to a number of terms that shall be defined to have the following meanings unless a contrary intention is apparent.

### Oxidizing Sulfur Containing Compounds

In certain embodiments the invention relates to a catalytic material comprising a tetra-n-butylammonium (TBA) and iron salt of Br⁻/Br₃⁻, which can provide NO₃⁻, NO₂⁻ or NO⁺ species. Such a material is extremely effective in catalyzing the oxidative decontamination of 2-chlorethyl ethyl sulfide (CEES), the optimal stimulant for mustard (HD), mercaptans (thiols), a principal odorant in human environments, and mixtures of amines, aldehydes, and sulfur compounds that constitute the principal air pollutants, using only ambient air as the oxidant. With regard to certain embodiments, catalysts attack and decontaminate the nerve agent, VX, toxic industrial chemicals (TICs), and odorous household compounds.

In some embodiments, the invention relates to catalyzing the conversion of the HD simulant, 2-chloroethyl ethyl sulfide (CEES) a sulfur containing compound to the corresponding sulfoxide by using O₂ in the air as the only oxidant under ambient conditions (no heat, light, additives or other requirements are needed for activity).

Equation 1 gives the proposed oxidation process for certain embodiments. However, it is not intended that embodiments of the disclosure be limited by any particular mechanism.

(ClCH₂CH₂)₂S (HD)+½O₂→(ClCH₂CH₂)₂SO or “HDO” (1)

The oxidative product is the sulfoxide, overoxidation to the toxic sulfone was not detected. The corresponding sulfoxide, HDO, is a desirable decomposition products. It should be noted that mineralization of chemical warfare agents (CWAs) including HD typically requires the presence of light, high temperature or other energy sources. Unfortunately most decontamination needs aren't compatible with the presence of these entities. Unlike typically stoichiometric decontaminating reagents embodiments of the present disclosure are catalytic, stable, and can be applied/used in either solid forms or in organic solvents.

### Degrading Contaminants

As mentioned above, embodiments of the present disclosure can be used degrade contaminants. In an embodiment, the contaminants (or composition or mixture) are exposed to the composition or mixture (or contaminants) in air or an atmosphere including dioxygen at ambient temperatures. Upon exposure to the composition or mixture, the contaminants are catalytically degraded over a period of time (e.g., about 5 sec to several hours or about 1 to 10 hours).

In an embodiment, the compositions or mixtures can be used in solvents such as, but not limited to, non-polar organic solvents, alkanes, low molecular weight fluorocarbons, chlorocarbons, hydrocarbons, and combinations thereof. In particular, the solvents can include, but are not limited to, petroleum ether, paraffin oil, benzene, toluene, and combinations thereof.

Some compositions or mixtures are effective at degrading contaminants such as warfare agents (e.g., chemical and/or biological warfare agents) and pollutants (e.g., air and water). Not intending to be bound by any particular theory, embodiments of the disclosure may be effective as catalysts with respect to the oxidation of chemical and/or biological warfare agents or pollutants. In particular, compositions of the present disclosure are effective at oxidizing 2-chloroethyl ethyl sulfide (CEES), a mustard gas stimulant, thiols, which is the hydrolysis product of VX, tertiary amines such as the side chain in VX, or propanethiol, using oxygen (O₂) or air as the terminal oxidant under ambient temperature.

Embodiments of the compositions or mixtures described herein are capable of degrading a single contaminant or multiple contaminants in an environment. The term “environment” as used herein refers to any media that contains at least one contaminant. For example, in one embodiment, the environment may comprise a liquid phase. In another embodiment, the environment may comprise a gas phase.

The term “degrade” or “degradation” refers to, but is not limited to, the degradation of the contaminant, the conversion of the contaminant into another compound that is either less toxic or nontoxic, or the adsorption of the contaminant by the compositions of the present disclosure. The compositions or mixtures may be able to degrade the contaminant by a number of different mechanisms. For example, the compositions or mixtures of the present disclosure can aerobically oxidize the contaminant.

Contaminants that can be degraded by using embodiments of the present disclosure include, but are not limited to, chemical warfare agents, biological warfare agents, or combinations thereof, and air pollutants or water pollutants. Exemplary chemical warfare agents include mustard gas and sarin, while an exemplary biological warfare agent includes anthrax and exemplary air pollutants include sulfur compounds, amines, and aldehydes, and combinations thereof.

Some of the chemical warfare agents and biological warfare agents disclosed in Marrs, Timothy C.; Maynard, Robert L.; Sidell, Frederick R.; Chemical Warfare Agents Toxicology and Treatment; John Wiley & Sons: Chichester, England, 1996; Compton, James A. F.; Military Chemical and Biological Agents Chemical and Toxicological Properties; The Telford Press: Caldwell, N.J., 1988; Somani, Satu M.; Chemical Warfare Agents; Academic Press: San Diego, 1992, which are incorporated herein by reference in their entirety, may be degraded by embodiments of the present disclosure.

Furthermore, contaminants that may be degraded using embodiments of the present disclosure generally include, but are not limited to, the following: aldehydes, aliphatic nitrogen compounds, sulfur compounds, aliphatic oxygenated compounds, halogenated compounds, organophosphate compounds, phosphonothionate compounds, phosphorothionate compounds, arsenic compounds, chloroethyl compounds, phosgene, cyanic compounds, or combinations thereof. In one embodiment, the contaminant is acetaldehyde, methyl mercaptan, ammonia, hydrogen sulfide, diethyl sulfide, diethyl disulfide, dimethyl sulfide, dimethyl disulfide, trimethylamine, styrene, propionic acid, n-butyric acid, n-valeric acid, iso-valeric acid, pyridine, formaldehyde, 2-chloroethyl ethyl sulfide, carbon monoxide, or combinations thereof.

### Compositions

Compositions or mixtures of the present disclosure are typically used in the presence of an oxidizer to degrade a contaminant from the environment. An example of an oxidizer includes, but is not limited to, dioxygen. In an embodiment, oxygen present in the air is used as the oxidizer. In an embodiment, the degradation is conducted at ambient temperatures.

Compositions or mixtures of the present disclosure can be incorporated into a suitable material in order to facilitate the protection and/or degradation of a contaminant. The materials may include, for example, topical carriers, coatings, powders, filter materials, and/or fabrics, for example. A material as used herein refers to a media that incorporates one or more of the compositions or mixtures of the present disclosure.

Some compositions or mixtures can be incorporated into the material using techniques known in the art. In one embodiment, when the material is a topical carrier, powder, filter material, fabric or coating, the composition is directly added to and admixed with the material. In one embodiment, the components of the composition or mixture can be incorporated sequentially into the material. In another embodiment, the material is contacted with a composition or mixture comprising the composition and a solvent. The composition or mixture can be soluble, partially soluble, or insoluble in the solvent, depending upon the components of the composition and the solvent selected. In one embodiment, the solvent is water. In another embodiment, the solvent can be an organic solvent. Examples of solvents useful in embodiments of the present disclosure include, but are not limited to, acetonitrile, toluene, carbon dioxide, xylenes, 1-methyl-2-pyrrolidinone, or fluorinated media such as perfluoropolyether compounds.

The amount of each composition or mixture incorporated into the material varies, depending, at least in part, upon the contaminant to be degraded and the material that is selected. There is little restriction on the amount of each composition that can be incorporated into the material. In one embodiment, the composition or mixture is incorporated in the material is from 0.1 to 95% by weight of the material. In one embodiment, the lower limit of composition or mixture by weight maybe 0.05, 0.1, 0.5, 1.0, 2.0, 5.0, 10, 15, 20, 25, 30, 35, 40, 45, or 50%, and the upper limit maybe 30, 40, 50, 60, 70, 80, 90, or 95%. In one embodiment, when the material is a topical carrier, the composition or mixture is from 1 to 50% by weight of topical composition.

In an embodiment, compositions or mixtures of the present disclosure could be used in a wide variety of topical carriers. In an embodiment, a wide variety of powders and coatings (e.g., thermoplastics and thermosettings) known in the art can be used as the material in embodiments of the present disclosure. In one embodiment, the powder comprises activated carbon.

Almost any fabric can be developed to include one or more of the compositions or mixtures. In one embodiment, fabrics used to prepare garments, draperies, carpets, and upholstery can be used, and articles made from them are a part of this disclosure. In another embodiment, the fabric can be a knit or non-woven fabric. Useful fibers include, but are not limited to, polyamide, cotton, polyacrylic, polyacrylonitrile, polyester, polyvinylidine, polyolefin, polyurethane, polyurea, polytetrafluoroethylene, or carbon cloth, or a combination thereof. In still another embodiment, the fabric is prepared from cotton, polyacrylic, or polyacrylonitrile. In still another embodiment, the fabric is prepared from a cationic fiber. In another embodiment, the fabric comprises (1) a 50/50 blend of nylon-6,6 and cotton or (2) stretchable carbon blended with polyurethane or polyurea.

Further, any cellulosic fiber can incorporate the mixtures of the present disclosure. Examples of useful cellulosic fibers include, but are not limited to, wood or paper.

In one embodiment, when the material is a fabric or cellulosic fiber, the composition is about 0.1 to about 20% by weight of the material. Generally, the fabric or cellulosic fiber is dipped or immersed into the composition from several hours up to days at a temperature of about 0° C. to 100° C., preferably for 2 hours to 2 days at about 25° C. to 80° C. In another embodiment, the composition or mixture can be admixed with a resin or adhesive, and the resultant adhesive is applied to the surface of, or admixed with, the fabric or cellulosic fiber.

Typically, once the material has been contacted with the composition or mixture, the composition or mixture is dried in order to remove residual solvent. In one embodiment, the composition is heated from about 0° C. to 220° C. at or below atmospheric pressure, preferably from about 25° C. to 100° C. In another embodiment, the composition or mixture is dried in vacuo (i.e., less than or equal to about 10 torr).

In another embodiment, when the material is a fabric or cellulosic fiber, the composition or mixture can be incorporated into the fabric or cellulosic fiber by depositing the composition or mixture on the surface of an existing fabric or cellulosic fiber, covalently bonding the components of the composition or mixture to the fibers of the fabric or cellulosic fiber, impregnating or intimately mixing the composition with the fabric or cellulosic fiber, electrostatically bonding the components of the composition to the fabric or cellulosic fiber, or datively bonding the components of the composition or mixtures to the fabric or cellulosic fiber.

Embodiments of the compositions or mixtures of the present disclosure have a number of advantages over the prior art decontaminants. One advantage is that the compositions or mixtures of the present disclosure can catalytically degrade a contaminant from the environment starting within milliseconds of contact and can degrade the contaminant for extended periods of time, ranging from several days to indefinitely. Another advantage is that some compositions or mixtures can render the material more water-resistant and increase the surface area of the material.

### Experimental

### General Methods

All common reagents were purchased and used as delivered. Other than storing NOPF₆ at −30° C., no precautions were taken to keep materials away from air and moisture. We assumed that the acetonitrile contained some water.

Transmission Infrared spectra (3-5 wt. % sample in KBr) were recorded on a Thermo Electron Corporation Nicolet 6700 FTIR spectrometer. Reflectance spectra of pure samples were recorded on the same instrument using a diamond attenuated total reflectance accessory. Catalytic reactions (reactant and product) were quantified using Hewlett-Packard 5890 or 6890 gas chromatographs (GCs) equipped with HP-5 capillary columns [poly(5% diphenyl/95% dimethylsiloxane)] and flame ionization detectors (FIDS). UV-Visible spectra of the materials and reactions were acquired using a Agilent 8453 diode array spectrophotometer. Electrospray mass spectra were acquired on a Thermo Finnigan LTQ-FTMS in both positive and negative ion modes.

Normally stock solutions of the reagents combined to create a catalytic mixture were prepared in acetonitrile and mixed in the proper ratios to produce the required catalyst concentration in a 20 mL reaction vial equipped with a magnetic stir bar. Pure sulfide (CEES) or mercaptan (PrSH) and internal standard (1,3-dichlorobenzene, DCB) were added via auto-pipette. When the reaction called for 1.0 atm O₂ atmosphere, the vial was flushed with oxygen before capping. Those vials were then equipped with a balloon filled with 100% pure O₂ via a 25-gauge needle to maintain positive pressure and prevent air leaks. A thermostat-controlled water bath was used to maintain a constant temperature around the vials. Hamilton 7000 series micro syringes were used to deliver 0.1 μL of solvent to the GC inlet port. GC oven temperatures were adjusted to produce optimal peak separation in a minimal amount of time for each sulfide tested. Retention time and peak area were entered into Excel for plotting.

In a typical experiment, air is slowly flowed (20 mL/min) through a CEES or PrSH solution, then through the catalyst that is placed on a filter holder and finally through a glass tube containing carbon beads designed to adsorb organic compounds. All connections in the apparatus were sealed with Teflon tapes. The holder with catalyst and the glass tube with the carbon bead absorbent were weighed before and after runs of 2 or 3 hours. The percent of absorption is calculated as (moles absorbed substrate/total amount of substrate)×100.

An alternative evaluation of heterogeneous catalyst activity (catalyst present as an insoluble material) involved the use of a closed vessel containing the catalyst, oxidant (air), the contaminant and an internal standard to quantify removal of the contaminant. In a typical experiment with this configuration, a stock solution of propane thiol (PrSH) and internal standard (2,2 dimethyl butane) was prepared by mixing 1.2 mL of PrSH (5.0 M) with 1.0 mL of the standard (4.1 M). A 9 L glass vacuum desiccator container was equipped with a fan to circulate air and a 10 cm beaker cover containing 150 mg of solid catalyst was placed inside. The vessel's lid was equipped with a septum through which 300 μL of stock solution was introduced. Assuming that all the liquid vaporizes, the initial concentration of PrSH is 0.17 mM. To monitor the reaction 50 μL aliquots of gas were withdrawn and injected into a GC with FID detector.

### EXAMPLE 1

### Rapid Air-Based Oxidation of CEES to CEESO Catalyzed by Systems with Varying NO⁺ Counterions

NOPF₆ (5 mM) was mixed the 10 mM salt containing the co-catalyst anion, X⁻, 3 mL acetonitrile, 1 atm O₂, room temperature, 100 μL CEES. The conversion percentage was a fraction of sulfide (CEES) converted to sulfoxide after 1 hour. Turnover number (TON) was the moles of sulfide to moles of catalyst. THA refers to tetraheptylammonium and Domiphen Bromide refers to (dodecyldimethyl-2-phenoxyethyl)ammonium.

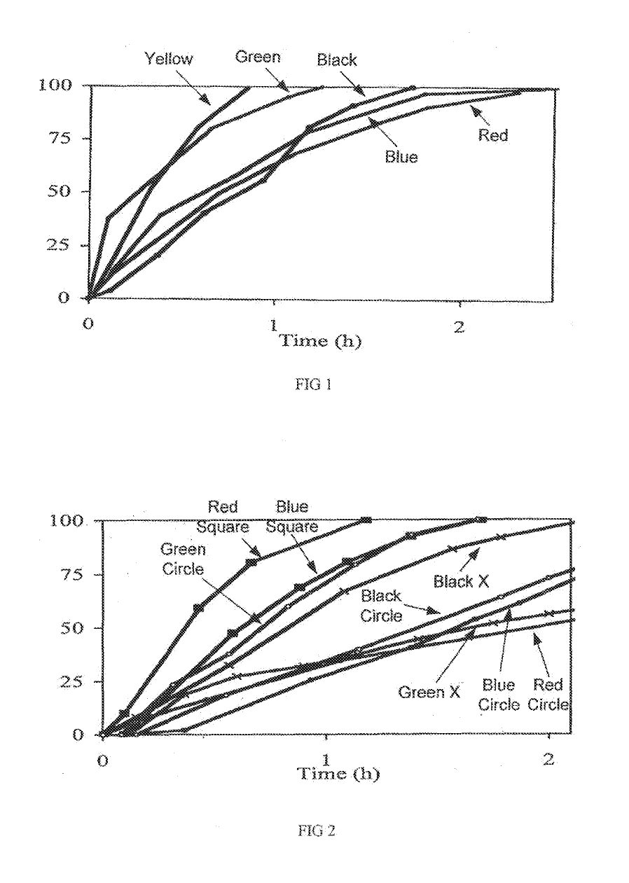

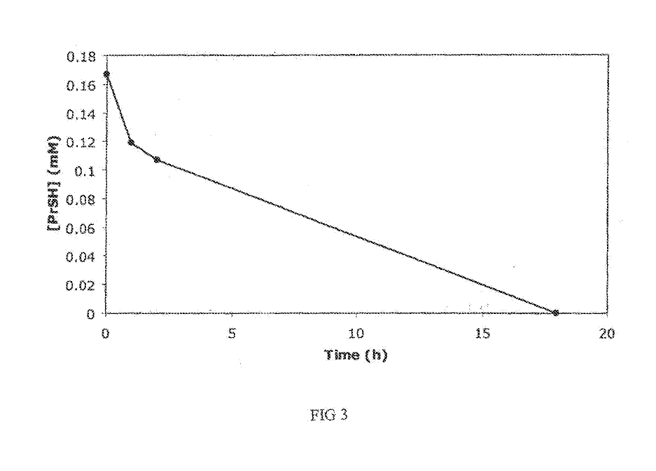

Representative data for air-based liquid-phase (acetonitrile solution) sulfoxidation of CEES catalyzed by nitrosonium ion (NO⁺) in the presence of varying counterions (counter-anions) are given in Table 1. These data indicate the combination of nitrosonium cation (NO⁺) and bromide anion (Br⁻) is the most active for catalytic air-based sulfoxidation of CEES. Several different d-electron-containing transition metal bromides were used as sources of bromide for the catalyst and the bromides of copper, iron and nickel were all quite active. Table 1 and FIGS. 1 and 2 used CEES as the substrate. Similar results are seen using another sulfide, tetrahydrothiophene (THT) as the substrate. These air-based sulfoxidations appear quite general for sulfides.

TABLE 1

| | | conversion | |
|---|---|---|---|
| | co-catalyst anion salt | (%) | TON |
| 1 | TBACN | 0 | 0.0 |
| 2 | TBACl | 4 | 0.2 |
| 3 | LiBr | 45 | 2.6 |
| 4 | KBr | 100 | 5.8 |
| 5 | NH₄Br | 100 | 5.8 |
| 6 | THABr | 100 | 5.8 |
| 7 | p-TsOH | 2 | 0.1 |
| 8 | TBASCN | 3 | 0.2 |
| 9 | TBAI | 0 | 0.0 |
| 10 | Domiphen Bromide | 50 | 2.9 |
| 11 | NiBr₂ | 100 | 5.8 |
| 12 | CuBr₂ | 100 | 5.8 |
| 13 | TBAFeBr₄ | 100 | 5.8 |

### EXAMPLE 2

### Catalytic Air Oxidation of PrSH to PrSSPr

TBANO₃ (5 mM), 5 mM CuBr₂, 5 mM p-TsOH, and 3 mL acetonitrile, were mixed under 1 atm O₂, room temperature with 100 μL CEES. Times at which mercaptan (PrSH) was added, total amount of added mercaptan (PrSH), turnover number=(moles of sulfide/moles of catalyst) were recorded.

The air-based liquid-phase (acetonitrile solution) oxidation of PrSH catalyzed by the combination of NO⁺/Br⁻ at different times is given in Table 2. PrSH is added to the catalytic system every 20 minutes and the conversion is measured by UV-Visible spectroscopy. The data show that the mercaptan is quickly oxidized and 100% converted to PrSSPr. The catalyst is active after about 9 turnovers.

TABLE 2

| Time (min) | PrSH (μl) | conversion (%) | TON |
|---|---|---|---|
| 0 | 40 | 100 | 0.76 |
| 20 | 80 | 100 | 1.52 |
| 44 | 120 | 100 | 2.28 |
| 65 | 160 | 100 | 3.04 |
| 90 | 200 | 100 | 3.8 |
| 118 | 240 | 100 | 4.56 |
| 138 | 280 | 100 | 5.32 |
| 157 | 320 | 100 | 6.08 |
| 185 | 360 | 100 | 6.84 |
| 205 | 400 | 100 | 7.6 |
| 230 | 440 | 100 | 8.36 |
| 250 | 480 | 100 | 9.12 |

The data suggest that that

(1) the presence of the d-electron metal cation leads to faster catalysts than in their absence (i.e. with only NO⁺ or other nitrogen oxide, “NOₓ” species present),

(2) NO⁺ (e.g., NOPF₆) can be replaced with more stable nitrate or nitrite salts in the presence of an acid such as toluenesulfonic acid (p-TsOH), and

(3) this air-based sulfoxidation (CEES+½O₂→CEESO) is catalyzed even faster by combinations of Cu and Fe salts.

The fastest catalyst system starting with available, inexpensive and nontoxic nitrate as the nitrogen oxide (“NOₓ”) source is a 1:1 molar mixture of Cu(NO₃)₂ (as the Cu and NOₓ source) and TBAFeBr₄ (as a Fe and bromide source), in the presence of acid (p-TsOH).

### EXAMPLE 3

### Consumption of 2-Chloroethyl Ethyl Sulfide (CEES) in the Gas Phase by Nitrate- and Bromide-Based Catalysts

The activity of the transition metal/NOₓ/Br materials for catalyzing CEES+½O₂→CEESO was also assessed with the catalyst present as an insoluble material and the substrate, CEES, present in the gas phase. Applications for catalysts such as those described herein entail the catalyst present as a solid (for example, as thin film, a powder, nanoparticles, or various forms immobilized on metal oxide, metal, fabric or other supports).

General conditions were run at room temperature with a flow rate of CEES-saturated air of 20 mL/min for the results in table 3. Table 3 provides for weight of CEES calculated from the weight changes of the filter holder before and after running the gas flow for the times noted (2 or 3 hours=hrs). Weight change after the first two hours of reaction and weight change after the first third hours of reaction were recorded. Weight of CEES calculated from the weight changes of the terminal glass tube containing the carbon adsorption beads before and after running the air flow for the times noted is designated as CEES-Pen. The % absorption is (weight of CEES absorbed by the catalyst layer/total amount of CEES introduced to the system by the air flow)×100.

Table 3 summarizes the adsorption of CEES from the gas phase (present in a CEES-saturated air stream) by our catalyst and various nitrate- and bromide-containing controls. The quantity of CEES that is absorbed by a filter transversed by the CEES-saturated air flow and also by a carbon-bead collector down-flow from the filter are tabulated. The full four-component catalysts (Cu/Fe/NOₓ/Br⁻) are the most reactive and remove the CEES very effectively. The control reactions with NOₓ only, Br⁻ only, etc. are far less effective.

TABLE 3

| | CEES- | | | | | |
|---|---|---|---|---|---|---|
| | absorbed, | | CEES-pen, | | absorption | |
| | (mg) | | (mg) | | % | |
| Catalyst (0.5 g) | 2 hrs | 3^{rd} hr | 2 hrs | 3^{rd} hr | 2 hrs | 3^{rd} hr |
| None | 0.6 | ~ | 9.0 | 5.4 | 6.3 | 0 |
| Cu(NO₃)₂ | 3.1 | 2.5 | 4.6 | 2.7 | 40.3 | 48.1 |
| TBABr/FeCl₃ | 4.4 | 0.9 | 3.2 | 1.8 | 57.9 | 33.3 |
| TBABr/TBANO₃ | 3.8 | ~ | 3.1 | 3.1 | 55.1 | 0 |
| TBABr/FeBr₃/ | 8.4 | 4.1 | 1.3 | 0.6 | 86.6 | 87.2 |
| Cu(NO₃)₂ | | | | | | |
| TBABr/FeCl₃/ | 10.0 | 6.0 | 2.2 | 1.0 | 82.0 | 85.7 |
| Cu(NO₃)₂ | | | | | | |
| TBABr/TBABr₃/ | 8.0 | | 1.5 | | 84.2 | |
| TBANO₃/Cu(NO₃)₂/ | | | | | | |
| NaHCO₃ | | | | | | |

### EXAMPLE 4

### Absorption and Conversion of CEES to CEESO by Gas Phase Catalysis

General conditions were run at room temperature with a flow rate of CEES-saturated air of 20 mL/min for 20 hours for the results in Table 4. The percent absorption is (weight of CEES absorbed by the catalyst layer/total amount of CEES induced to the system by the air flow)×100. Percent of absorbed sulfide converted to sulfoxide and turnover number (moles of sulfide/moles of catalyst) is provided. Table 5 shows data of absorption and turnover of CEES to CEESO by Gas Phase Catalysis after 40 hours

Tables 4 and 5 show the CEES that is trapped by the filter is actually catalytically transformed by the insoluble catalyst (immobilized on the filter) and air to the desired sulfoxide, CEESO. In other words, Cu/Fe/NOₓ/Br⁻ mixture also catalyzes the target process, CEES+½O₂→CEESO rapidly using only ambient air even though the catalyst is totally insoluble.

TABLE 4

| Catalysts | | Absorption (%) | Conversion (%) | TON |
|---|---|---|---|---|
| 1 | TBABr/FeCl₃/Cu(NO₃)₂ | 54.2 | ~ | ~ |
| 2 | TBABr/TBABr₃/ | 55.5 | 93.1 | 2.5 |
| | TBANO₃/Cu(NO₃)₂/ | | | |
| | NaHCO₃ | | | |

TABLE 5

| Catalyst | Absorption | TON |
|---|---|---|
| 2 (99.4 mg) | 110.4 mg | 11 |

### EXAMPLE 5

### Consumption of Propanethiol (PrSH) in the Gas Phase by Nitrate- and Bromide-Based Catalysts

Tables 6 and 7 show that PrSH vapor is efficiently and catalytically removed by air-based oxidation when present in the gas phase and the catalyst is immobilized. The quantity of PrSH and oxidation product, PrSSPr trapped by the catalyst in the filter as well as the catalytic oxidation of PrSH to PrSSPr is quantified. Table 7 shows absorption and Conversion of PrSH to PrSSPr by Gas Phase Catalysis in 2 hours

TABLE 6

| | PrSH | | | | | |
|---|---|---|---|---|---|---|
| | absorbed, | | PrSH pen, | | | |
| | (mg) | | (mg) | | % absorption | |
| Catalyst (0.32 g) | 1 h | 2 h | 1 h | 2 hr | 1 hrs | 2 hr |
| None | 24.3 | 8.2 | 57.9 | 87.1 | 23.6 | 8.6 |
| TBABr/TBABr₃/ | 97.2 | 73.6 | 29.3 | 6.8 | 84.2 | 91.5 |
| TBANO₃/Cu(NO₃)₂/ | | | | | | |
| NaHCO₃ | | | | | | |

TABLE 7

| Catalysts | | Absorption (%) | Conversion (%^{b} | TO^{c} |
|---|---|---|---|---|
| 1 | TBABr/TBABr₃/ | 82.5 | 68.5 | 7.2 |
| | TBANO₃/Cu(NO₃)₂/ | | | |
| | NaHCO₃ | | | |

Catalytic air-oxidation and removal of mercaptan in the sealed container is effective. As for oxidative decontamination in the flow-through system summarized in the tables above, oxidative removal using a closed system is also highly effective. The catalyst completely removed any detectable trace of PrSH in 18 hours. This translates to approximately 15 turnovers. The dish containing the catalyst weighed 0.05 g more after the reaction was complete. Washing the catalyst and dish with chlorobenzene and analyzing the liquid via GC did not reveal any PrSH, nor were we able to detect the oxidized product propyl disulfide (PrSSPr). Washing the vessel with chlorobenzene yielded similar results.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified. In addition, the phrase “about ‘x’ to ‘y’” includes “about ‘x’ to about ‘y’”.

It should be emphasized that the above-described embodiments of the present disclosure, particularly, any “preferred” embodiments, are merely possible examples of implementations, and are merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

1. A composition comprising:
a M1 compound source, a M2 compound source, a NOₓ compound source, where x is 1, 2, or 3, and a Br compound source, wherein the composition including M1/M2/NOₓ/Br⁻ has the characteristic of being able to degrade a contaminant.

2. A mixture comprising:
a M1 compound source, a M2 compound source, a NOₓ compound source, where x is 1, 2, or 3, and a Br compound source, wherein the mixture including M1/M2/NOₓ/Br⁻ has the characteristic of being able to degrade a contaminant.

3. The composition or mixture of claim 1, wherein M1 is Cu and M2 is Fe.

4. The composition or mixture of claim 1, wherein the composition is a catalyst.

5. A composition comprising:
a M1 compound, and a Br compound source, and a NOₓ source, wherein the composition including M1/NOₓ/Br⁻ has the characteristic of being able to degrade a contaminant.

6. A mixture comprising:
a M1 compound, and a Br compound source, and a NOₓ source, wherein the composition including M1/NOₓ/Br⁻ has the characteristic of being able to degrade a contaminant.

7. The composition or mixture of claim 5, wherein M1 is selected from Cu and Fe.

8. The composition or mixture of claim 5, wherein M1 is Cu.

9. A composition comprising:
a M1 compound, and a Br compound source, a NOₓ source where x is 1, 2, or 3, and E, wherein the composition including M1/E/NOₓ/Br⁻ has the characteristic of being able to degrade a contaminant, wherein E is selected from the group consisting of: tetraethylammonium (TEA) or tetra-n-butylammonium (TBA), tetrahexylammonium, tetraheptylammonium, tetramethylammonium, tetramethylphosphonium, tetraphenylphosphonium, tetraphenylarsonium, related polyalkyl or polyaryl cations, and any combination thereof.

10. A mixture comprising:
a M1 compound, and a Br compound source, a NOₓ source where x is 1, 2, or 3, and E, wherein the composition including M1/E/NOₓ/Br⁻ has the characteristic of being able to degrade a contaminant, wherein E is selected from the group consisting of: tetraethylammonium (TEA) or tetra-n-butylammonium (TBA), tetrahexylammonium, tetraheptylammonium, tetramethylammonium, tetramethylphosphonium, tetraphenylphosphonium, tetraphenylarsonium, related polyalkyl or polyaryl cations, and any combination thereof.

11. The composition or mixture of claim 9, wherein the composition including M1/E/NOₓ/Br⁻ includes Cu(NO₃)₂, TBANO₃, TBABr, TBABr₃, and NaHCO₃.

12. The composition or mixture of claim 9, wherein the composition is a catalyst.

13. A composition, comprising:
M1/NOₓ:EM2(Hal)_{y}, wherein M1 and M2 are independently selected from:
copper (Cu), iron (Fe), chromium (Cr), cobalt (Co), nickel (Ni), manganese (Mn), and zinc (Zn); wherein E is selected from the group consisting of: tetraethylammonium (TEA) or tetra-n-butylammonium (TBA), tetrahexylammonium, tetraheptylammonium, tetramethylammonium, tetramethylphosphonium, tetraphenylphosphonium, tetraphenylarsonium, related polyalkyl or polyaryl cations, and any combination thereof; wherein Hal is selected from the group consisting of: bromine (Br), chlorine (Cl), and any combination thereof; wherein y is 2 or 4; and wherein “x” is 1, 2, or 3.

14. A mixture, comprising:
M1/NOₓ and EM2(Hal)_{y}, wherein M1 and M2 are independently selected from: copper (Cu), iron (Fe), chromium (Cr), cobalt (Co), nickel (Ni), manganese (Mn), and zinc (Zn); wherein E is selected from the group consisting of: tetraethylammonium (TEA) or tetra-n-butylammonium (TBA), tetrahexylammonium, tetraheptylammonium, tetramethylammonium, tetramethylphosphonium, tetraphenylphosphonium, tetraphenylarsonium, related polyalkyl or polyaryl cations, and any combination thereof; wherein Hal is selected from the group consisting of: bromine (Br), chlorine (Cl), and any combination thereof; wherein y is 2 or 4; and wherein “x” is 1, 2, or 3.

15. The composition or mixture of claim 13, wherein Hal is bromine (Br), E is tetra-n-butylammonium (TBA), M1 is Cu, M2 is Fe, and NOₓ is [NO₃⁻].

16. The composition or mixture of claim 13, further comprising an acid.

17. The composition or mixture of claim 16, wherein the acid is selected from the group consisting of an alkylsulfonic acid or fluorinated derivatives thereof, an arylsulfonic acid or fluorinated derivatives thereof, and any combination of these.

18. The composition or mixture of claim 16, wherein the acid is selected from the group consisting of: toluenesulfonic acid, sulfonic acid, nitric acid, and any combination thereof.

19. The composition or mixture of claim 1, wherein the composition is included in a material.

20. The composition or mixture of claim 19, wherein the material is selected from a fabric, a topical carrier, a powder, a filter material, a coating or a porous material, including nanoporous or microporous materials.

21.-33. (canceled)
